(19) United States
(12) Patent Application Publication
(10) Pub. No.: US 2011/0234547 A1
(43) Pub. Date: Sep. 29, 2011

(54) STYLUS

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/840,450

(22) Filed: Jul. 21, 2010

(30) Foreign Application Priority Data
Mar. 25, 2010 (CN) 201010132386.3

(51) Int. Cl. G06F 3/033

(52) U.S. Cl. 345/179; 178/19.01

(57) ABSTRACT

A stylus comprises a housing, a stylus body, a pin, a shell and a latching element. The housing has a receptacle defined therethrough. The stylus body is accommodated in the receptacle. The pin transversely passes through the stylus body and the housing to retain the stylus body to the housing. The shell is slidably accommodated in the receptacle, the shell has a first stopping hole defined at one end thereof and a protrusion located adjacent to the first stopping hole, the first stopping hole is used for latch with the pin to hold stylus in a retracted state. The latching element is mounted in the receptacle and spaced apart from the stylus body, the latching element having a latching cantilever having a second stopping hole defined therethrough, the second stopping hole being used for latching with the protrusion to hold the stylus in an extended state.

### CROSS-REFERENCE TO RELATED APPLICATIONS

This application is related to co-pending U.S. patent applications (Attorney Docket No. US32726 and US32733), entitled “STYLUS”, by SHI-XU LIANG. These application have the same assignee as the present application and have been concurrently filed herewith. The above-identified applications are incorporated herein by reference.

### BACKGROUND

1. Technical Field

This exemplary disclosure generally relates to retractable/extendable styluses.

2. Description of Related Art

It is well-known that a variety of devices include a touch screen. Examples of such devices include smart phones, personal digital assistants (PDA), pagers, personal organizers, and the like. These devices typically include a display module under the touch screen. The display module generates target images associated with menu options, programs, user choices, and other operations. The user controls the device by pressing the touch screen over the target image with a stylus. However, typical styluses can be inconvenient to retract or extend.

Therefore, there is room for improvement within the art

### BRIEF DESCRIPTION OF THE DRAWINGS

Many aspects of the exemplary stylus can be better understood with reference to the following drawings. The components in the various drawings are not necessarily drawn to scale, the emphasis instead being placed upon clearly illustrating the principles of the exemplary stylus. Moreover, in the drawings, like reference numerals designate corresponding parts throughout the diagrams.

FIG. 1 is an exploded view of an exemplary stylus.

FIG. 2 is an assembled view of the stylus shown in FIG. 1.

FIG. 3 is a cut-away view of the stylus shown in FIG. 2, and wherein the stylus is in a retracted state.

FIG. 4 is a cross-sectional view of the stylus in FIG. 2, and where the stylus is in an extended state.

### DETAILED DESCRIPTION

In this exemplary embodiment, the stylus is used to contact a touch screen display of an electronic device such as a mobile telephone. The mobile telephone described herein is a representation of the type of wireless communication device that may benefit from the exemplary embodiment. However, it is to be understood that the exemplary embodiment may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) that have wireless communication capability and the like. Accordingly, any reference herein to the mobile telephone should also be considered to apply equally to other portable wireless electronic devices.

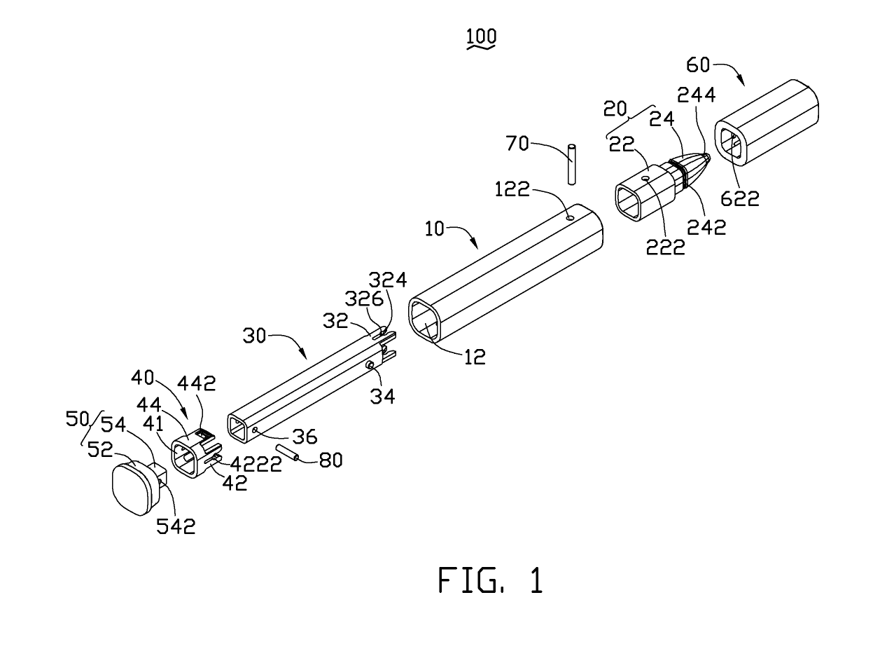

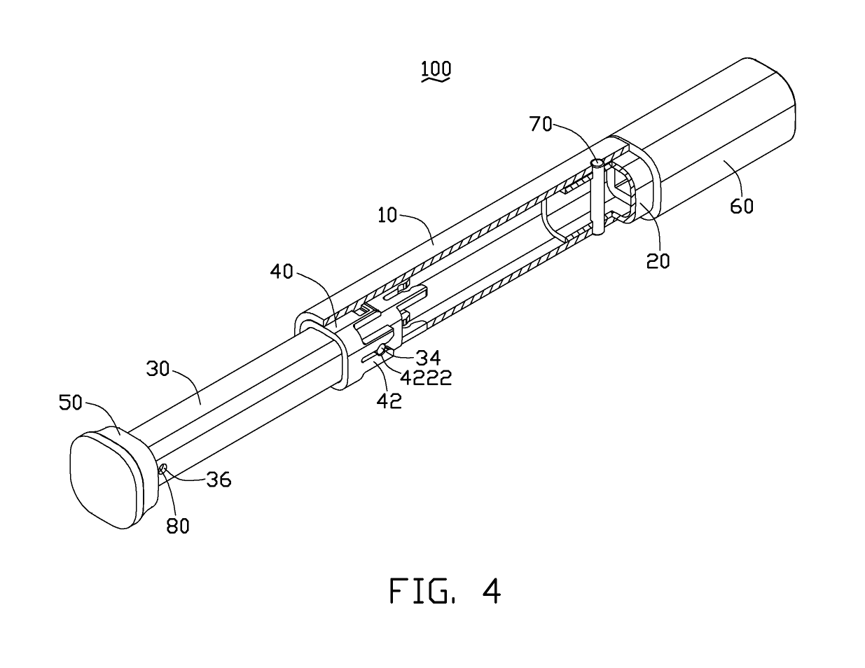

Referring to FIGS. 1 and 4, the stylus 100 includes a housing 10, a stylus body 20 mounted to one end of the housing 10, a shell 30 slidably mounted in the housing 10, a latching element 40 mounted to another end of the housing 10, a cap 50 mounted to the shell 30 and a cover 60 covering and protecting the distal end of the stylus body 20. The stylus body 20 is mounted to the housing 10 by a pin 70, and the cap 50 is mounted to the shell 30 by a post 80.

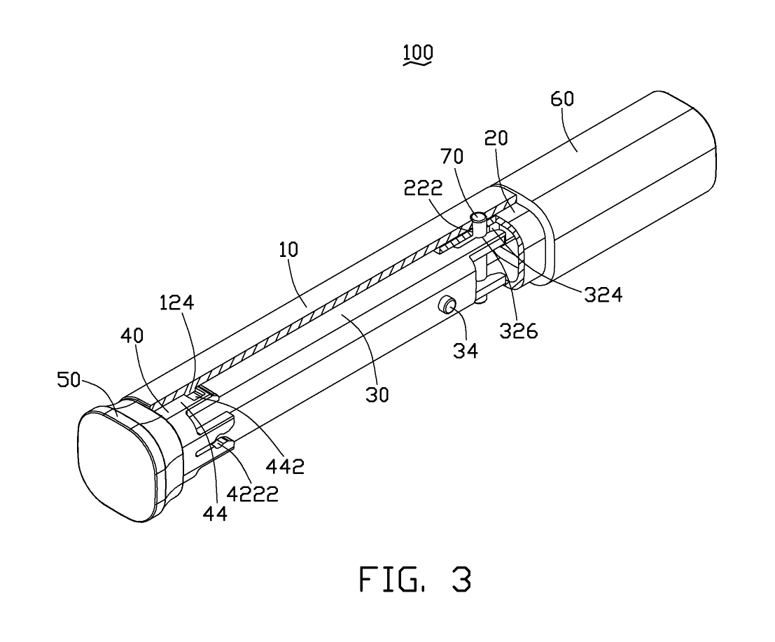

The housing 10 is hollow, and longitudinally defines a receptacle 12 therethrough. The housing 10 further includes two aligned retaining holes 122 defined at one end thereof. The retaining holes 122 are for retaining the pin 70 to the housing 10. The housing 10 may further includes a block 124 (see FIG. 3) protruding from an inner surface thereof opposite to retaining holes 122. The block 124 is for retaining the latching element 40 in the housing 10.

The stylus body 20 includes a hollow retaining portion 22 and a head 24 protruding from one end of the retaining portion 22. The retaining portion 22 transversely defines an opening 222. The head 24 has a retaining slot 242 defined near the retaining portion 22. The retaining slot 242 is for holding the cover 60 on the stylus body 20.

The shell 30 is tubular and has generally the same shape as, but is slightly smaller than the receptacle 12 of the housing 10 so the shell 30 can be accommodated in the receptacle 12 and slide relative to the housing 10. The shell 30 has one stopping mechanism formed at one end thereof. The stopping mechanism has two opposite arms 32 protruding from an end thereof and a protrusion 34 protruding an outer surface thereof adjacent to the arms 32. Each arm 32 has a first stopping hole 326 defined therethrough for latching with the pin 70 so the shell 30 can be held in a retracted state like shown in FIG. 3. Each arm 32 further includes a guiding groove 324 defined at a distal end thereof and communicating with the first stopping hole 326. The guiding grooves 324 are for guiding the pin 70 to the first stopping holes 326. The first stopping holes 326 are sized and dimensioned to tightly fit the pin 70 therein when the shell 30 is slid to the retracted state shown in FIG. 3, and the guiding grooves 324 are smaller than the pin 70 such that the pin 70 can not freely slide out of the first stopping holes 326 when the pin 70 is fit in the first stopping holes 326. Thus, the shell 30 can be firmly held in the retracted state shown in FIG. 3 by the tight fit engagement between the first stopping holes 326 and the pin 70. The protrusion 34 is for holding the shell 30 in an extended state shown in FIG. 4. The shell 30 further defines two retaining troughs 36 near another end thereof opposite to the arms 32. The retaining troughs 36 are for retaining the post 80 on the shell 30.

The latching element 40 is tubular, and longitudinally defines a chamber 41. The latching element 40 is tightly fitted around the shell 30 and can not rotate relative to the shell 30. Protruding from one <watch word order> end of the latching element 40 are a latching cantilever 42 and a retaining cantilever 44. The latching cantilever 42 has a second stopping hole 4222 defined therethrough for latching with the protrusion 34 so the shell 30 can be held in the extended state like shown in FIG. 4. The second stopping hole 4222 is sized and dimensioned to tightly fit the protrusion 34 therein when the shell 30 is slid to the extended state shown in FIG. 4. Thus, the shell 30 can be firmly held in the extended state shown in FIG. 4 by the tight fit engagement between the second stopping hole 4222 and the protrusion 34. The retaining cantilever 44 has a retaining recess 442 recessed therein for latching with the block 124 to retain the latching element 40 to the housing 10.

The cap 50 includes a board 52 and a plunger 54 protruding from one side of the board 52. The plunger 54 is inserted in the shell 30 and defines an aperture 542 therethrough. When the plunger 54 is inserted in the shell 30, the aperture 542 is aligned with the retaining troughs 36, and the post 80 is tightly fitted in the aperture 542 and the retaining troughs 36 so the cap 50 is mounted to the shell 30.

The cover 60 has two opposite securing portions 622 protruding from an inner surface of the cover 60. The securing portions 622 latch with the retaining slots 242 to hold the cover 60 on the stylus body 20.

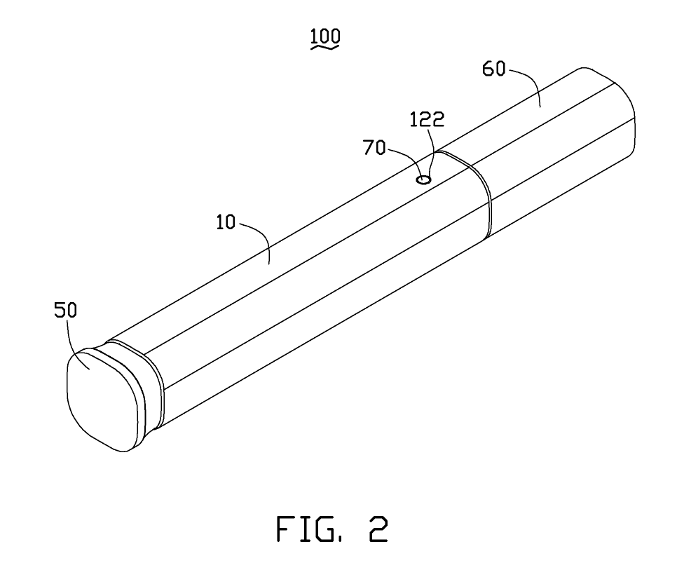

Referring to FIG. 1-3, in assembly, the stylus body 20 is inserted in the receptacle 12, the opening 222 is aligned with the retaining holes 122. The pin 70 is inserted in the opening 222 and the retaining holes 122 to latch the stylus body 20 to the housing 10. The shell 30 is inserted in the receptacle 12. The latching element 40 is inserted in the receptacle 12 until the retaining recess 442 latch with the block 124, so the latching element 40 is mounted to the housing 10, and the shell 30 passes through the chamber 41 of the latching element 40. The plunger 54 of the cap 50 passes through the chamber 41 and then enters into the shell 30, until the aperture 542 aligns with the retaining troughs 36. The post 80 is inserted in the retaining troughs 36 and the aperture 542 to latch the cap 50 to shell 30. Finally the cover 60 is positioned on the stylus body 20 to complete assembly of the stylus 100.

Referring to FIG. 4, in operation, the cap 50 is pulled away from the housing 10, the pin 70 is slid out of the first stopping holes 326, until the protrusion 34 latches with the second stopping hole 4222 like shown in FIG. 5. Thereby, the stylus 100 is located in the extended state and is ready to use.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A stylus, comprising:
a housing having a receptacle defined therethrough;
a stylus body accommodated in the receptacle;
a pin transversely passing through the stylus body and the housing to retain the stylus body to the housing;
a shell slidably accommodated in the receptacle, the shell having a first stopping hole defined at one end thereof and a protrusion located adjacent to the first stopping hole, the first stopping hole used for latching with the pin to hold the stylus in a retracted state;
a latching element mounted in the receptacle and spaced apart from the stylus body, the latching element having a latching cantilever having a second stopping hole defined therethrough, the second stopping hole being used for latching with the protrusion to hold the stylus in an extended state.

2. The stylus as claimed in claim 1, wherein the latching cantilever protrudes toward the stylus body.

3. The stylus as claimed in claim 1, wherein the housing has a block protruding from an inner surface thereof, the latching element has a retaining cantilever protruding toward the stylus body, the retaining cantilever has a retaining recess recessed therein for latching with the block to latch the latching element to the housing.

4. The stylus as claimed in claim 1, wherein the stylus further includes a cap including a board and a plunger extending from the board; the plunger is mounted to the shell.

5. The stylus as claimed in claim 1, wherein the housing further includes two aligned retaining holes defined at one end thereof; the stylus body has a hollow retaining portion that has an opening transversely defined therethrough, the opening is aligned with the retaining holes; the pin is inserted in the opening and the retaining holes to latch the stylus body to the housing.

6. The stylus as claimed in claim 1, wherein the shell has the same shape as, but is slightly smaller than the receptacle of the housing so the shell can be accommodated in the receptacle and slides relative to the housing.

7. The stylus as claimed in claim 1, wherein the shell has an arm protruding from one end thereof, the first stopping hole is defined through arm.

8. The stylus as claimed in claim 7, wherein the arm further includes a guiding groove defined in a distal end thereof and communicating with the first stopping hole, the guiding groove is for guiding the pin to the first stopping holes.

9. The stylus as claimed in claim 8, wherein the first stopping hole is sized and dimensioned to tightly fit the pin therein when the shell is slid to the retracted state.

10. The stylus as claimed in claim 9, wherein the guiding grooves is smaller than the pin such that the pin can not freely slide out of the first stopping holes when the pin is fit in the first stopping hole.

11. A stylus, comprising:
a housing having a receptacle defined therethrough;
a stylus body accommodated in the receptacle;
a pin transversely passing through the stylus body and the housing to retain the stylus body to the housing;
a latching element securely received in the receptacle and spaced apart from the housing,
a shell slidably accommodated in the receptacle, the shell having a stopping mechanism for selectively latching with one of the pin and the latching element to hold the stylus in a retracted state or in an extend state

12. The stylus as claimed in claim 11, wherein the stopping mechanism includes two arms extending from one end of the shell, each arm has a first stopping hole defined therein and used for latching with the pin to hold the stylus in the retracted state.

13. The stylus as claimed in claim 12, wherein the arm further includes a guiding groove defined a distal end thereof and communicating with the first stopping hole, the guiding groove is for guiding the pin to the first stopping holes.

14. The stylus as claimed in claim 13, wherein the first stopping hole is sized and dimensioned to tightly fit the pin therein when the shell is slid to the retracted state.

15. The stylus as claimed in claim 14, wherein the guiding grooves is smaller than the pin such that the pin can not freely slide out of the first stopping holes when the pin is fit in the first stopping hole.

16. The stylus as claimed in claim 11, wherein the stopping mechanism includes at least one protrusions protruding from outer surface of the shell, the latching element has a second stopping hole defined therein and used for latching with the pin to hold the stylus in the extend state.

17. The stylus as claimed in claim 16, wherein the latching element includes a latching cantilever protruding toward the stylus body, the second stopping hole is defined in the latching cantilever.

18. The stylus as claimed in claim 11, wherein the housing has a block protruding from an inner surface thereof, the latching element has a retaining cantilever protruding toward the stylus body, the retaining cantilever has a retaining recess recessed therein for latching with the block to latch the latching element to the housing.

19. The stylus as claimed in claim 11, wherein the stylus further includes a cap including a board and a plunger extending from the board; the plunger is mounted to the shell.
